(19) United States
(12) Patent Application Publication
(10) Pub. No.: US 2004/0074401 A1
(43) Pub. Date: Apr. 22, 2004

(54) Automated production of packaged cooked meals

(76) Inventors: Gayle Edith McMaster, Auckland (NZ); Michael Adair McMaster, Auckland (NZ)

Correspondence Address: FINNEGAN, HENDERSON, FARABOW, GARRETT & DUNNER, LLP, 1300 I STREET, NW, WASHINGTON, DC, 20005, US

(21) Appl. No.: 10/451,242

(22) PCT Filed: Dec. 21, 2001
(86) PCT No.: PCT/NZ01/00294

(30) Foreign Application Priority Data
Dec. 22, 2000 (NZ) 509154
Aug. 9, 2001 (NZ) 513462

(51) Int. Cl. A23L 1/00

(52) U.S. Cl. 99/485

(57) ABSTRACT

An aseptic method of preparing meals using automated means to place food portions of different types such as meat, lamb, chicken, vegetables, starches, rice, and potatoes within individual food type moulds (21) and into an in-line oven (1); each type of the food portions is then cooked as the moulds (21) are conveyed (19) through the oven; and automated means such as a spatula (22) and mould holder and lifting apparatus (24) are used to remove the food from the oven and moulds; and assembling the individual food portions to form a meal within a package (23). Also disclosed is a monitoring means for sue in a multiple stage sequential automatic food processing system that includes a means (15) for assigning a unique identification code or barcode to each individual food portion and sensors for measuring values of predetermined parameters (e.g. temperature, duration) of the process for said identified portions.

### TECHNICAL FIELD

This invention relates to a method and apparatus for the production of meals.

More specifically this invention relates to the method and apparatus used in the production of meals using substantially automatic means.

### BACKGROUND ART

Ready-made meals are increasing in popularity around the world. Today large numbers of people find they do not have the time in their busy schedules to spend the necessary time preparing a meal from scratch.

As a result of this the numbers of ready-made meals sold are increasing significantly. However, these meals have not really increased in quality with the increase in demand. Generally ready-made meals tend to be bland, unappetising meals which don't lend themselves easily to enjoyment. Rather they are merely a way of gaining a person's daily calorific intake.

A large proportion of the meals sold are prepared, refrigerated and sold as meals that merely need heating by either microwave or conventional oven.

Generally these meals look and taste like mass-produced bland meals. However, the alternative being the cost involved with eating at a restaurant daily would be prohibitively high for most consumers.

Existing ready-made meals currently don't cater for the large group of people who want restaurant quality meals without having to pay the prices of going to a restaurant.

It is common knowledge that food which is not kept refrigerated spoils relatively quickly. However, even if kept refrigerated food does still retain a certain life span before it spoils. The refrigerated ready-made meals which make up the prior art have a life expectancy of between a week and ten days. A major factor in determining the life span of these products is the method of production of the meal.

Current methods of production involve human input at the majority stages of production. This human contact during and post cooking introduces many strains of bacteria such as listeria. The presence of such bacteria hastens the food spoiling and is associated with problems such as food poisoning.

Several pieces of prior art have overcome the problem of human input by placing food into the packaging it is to be transported and sold in before the cooking process. Examples of this are U.S. Pat. No. 4,956,532 & U.S. Pat. No. 4,974,503.

There are significant problems associated with this type of processing. Different food groups require different temperatures, duration and even types of cooking, for example, grilling or steaming.

U.S. Pat. No. 4,956,532 and U.S. Pat. No. 4,974,503 patents use microwave technology whereby the microwaves are emitted at different intensities thereby effectively cooking the different types of food portions according to their requirements. There are significant disadvantages associated with this method of processing. The equipment is complicated, and expensive to produce requiring specialised engineering. Conventional cooking equipment cannot be used with these methods as it cannot process differing food types simultaneously. Further, as the cooking apparatus is specifically engineered it takes significant reworking to alter the order in which the food is assembled.

The reduced life span of between a week and ten days due to the human contact means that after the time for transportation the shelf life for such ready-made meals are in the vicinity of five days to a week. The short shelf life results in a large proportion of these meals spoiling, thus resulting in losses for the manufacturers and retailers, inconvenience and annoyance for customers.

There are meals currently available with an extended shelf life, as detailed in U.S. Pat. No. 5,904,946. These meals are prepared using human input throughout the cooking process. Subsequently, after the meals have been placed into their packaging they are then hermetically sealed and heated to at least 74° C., this heating effectively sterilises the meal.

However, the subsequent heating results in further cooking of the food portions which can result in overcooking and a poorer quality meal. Further, when the meals are re-cooked to 74° C. all the portions are subjected to the same conditions regardless of whether they are a meat portion or a vegetable portion. These differing portions have differing requirements; a smaller vegetable portion will heat up significantly faster than a larger meat portion resulting in uneven cooking.

Even with the absence of human contact during the cooking, chilling and packing processes there are still problems. The aseptic conditions dramatically improve the shelf life for ready-made meals, however, the conditions although substantially aseptic are not uniform across the entire process.

For example, during the cooking process some areas are naturally hotter than others. This results in some food portions being cooked more or less than others.

Another example is during the chilling process some food portions may be chilled more slowly than others, therefore giving microorganisms present in the portions greater time to reproduce. This in turn increases the chances of food spoilage, and resultant food poisoning.

Current production methods of ready-made or pre-packaged meals monitor quality on a batch by batch basis. This system does not take into account the varying conditions which individual food portions may be subjected to.

It is known in the art, for example WO 87/03784 that a product can be cooked according to its individual requirements by use of a barcode to identify a particular requirement of a food. WO 87/03784 discloses an apparatus for making bread products whereby the variable baking parameters are dependent upon a product's ingredients which are identified by a barcode. This type of process enables a food to be cooked according to the requirements of its ingredients however, again it does not enable more than one group of food to be processed concurrently. Further, the identification of the food type merely provides information for the cooking process. It does not enable multiple food portions to be combined to form a meal or subsequently have actions taken against the meals.

Apparatus is known in the art for processing food whereby the internal conditions are monitored and if they fall outside a set parameter range then the apparatus's settings are adjusted as a result, for example U.S. Pat. No. 5,253,564. This prior art however still -falls within the batch by batch processing of food. This type of prior art is unable to monitor the individual requirements and statistics for an individual food portion. Therefore, if the food portions are not exactly uniform they will heat, and chill at different speeds creating quality control problems.

If one meal containing a portion which may have been undercooked spoils, or results in food poisoning it has serious consequences. Entire batches of meals need to be recalled. In addition, there is no accurate way of diagnosing the exact cause of the problem.

There is currently no exact way of gauging the consistency of the process, and no way of exactly determining the quality of each supplier.

Current methods of quality and auditability are undertaken on a macro scale, not on an individual basis.

It is an object of the present invention to address the foregoing problems or at least to provide the public with a useful choice.

Further aspects and advantages of the present invention will become apparent from the ensuing description, which is given by way of example only.

### DISCLOSURE OF INVENTION

According to one aspect of the present invention there is provided a method of preparing meals,

characterised by the steps of:

(a) using automated means to place food portions of different types into at least one oven wherein each food portion is contained within a mould; and

(b) cooking the food portions in an oven; and

(c) using automated means to remove the food from the oven; and

(d) assembling the individual food portions into a meal within the package using automated means.

The oven may come in any suitable form. For example, the oven may be an inline cooker, microwave or a steamer. However, these examples should not be viewed as limiting in any way.

In preferred embodiments this oven is an in-line cooker with dew controls and adjustable temperatures, and controls to vary the cooking duration. The in-line oven is able to be adjusted to cook the food according to its type and specific meal requirements.

The ability to vary the oven's temperature, cooking time, or humidity is necessary to ensure each portion is cooked according to its requirements. Meat portions have very different requirements to those of vegetable portions. Further, it is necessary to be able to control the ovens to enable different styles of cooking, for example braising, grilling or steaming. Also, different meat portions will have distinct requirements; for example, lamb shanks require very different conditions than fish or chicken.

The different types of food portions may come in any suitable form for the production of meals. For example, types of food portions could be meat, vegetables, or starches such as rice, potato or polenta.

The moulds within which the food portions are contained will be referred to as shape holders, and may come in any suitable form. For example, the shape holders may be a mould for retaining rice portions, or means for retaining asparagus spears in the configuration required for packaging into a meal.

It should be appreciated that the use of moulds in cooking is known. However, the use of moulds is restricted to processes whereby one product is produced at a time, moulds have not previously been used to prepare whole meals concurrently, for example, the use of cake tins, terrine moulds or as disclosed in U.S. Pat. No. 5,269,216 moulds to shape meat products. These uses of moulds in the past have been used to produce a single product for example a cake, terrine, or meat product in a specific shape. However, previously if these subsequent products have been combined with other types of products there has been human input into the process. This requires extra labour, and introduces a further source of contamination into the process. Therefore the use of moulds although widely known for the production of a single product have not been capable of producing a meal automatically without human input.

In preferred embodiments the moulds in accordance with the present invention are shape holders/moulds having peripheral boundaries, however not containing a base. This allows for easy removal of food portions from the shape holders. The shape holders preferably have a lip allowing for easy removal from trays and processing using automated means.

The automated means may come in any suitable form for example, clamps, pincers, vacuums, spatulas, conveyors or any other combination of automated means. This however must not be viewed as limiting in any way.

In preferred embodiments the method for preparing meals utilises at least one conveyor, and a means for removing the food from the shape holders. The method of producing the meals also utilises automated means for placing the food portions within the packaging, and hermetically sealing these packages.

The use of these automated means throughout the process results in no human contact with the food except for during the preparatory process. Thus, any bacterial contamination introduced by human contact is killed in the cooking process.

In preferred embodiments the method of assembling the different types of food portions into a package is by way of an apparatus as described later in the specification.

In preferred embodiments the method of assembling meals having different types of food portions is further characterised by the steps of:

(a) retaining the food portions after they are cooked in a holding area; and

(b) identifying when different types of food portions are to be retained in the holding area and the sufficient retention period so as to coordinate the assembly of a complete meal; and

(c) assembling meals from the different types of food portions by automated means.

The holding area may come in any suitable form. In preferred embodiments this holding area will be a blast chiller.

The means for identifying when the food portions are contained in the holding area and the duration of the retention may come in any suitable form. For example, this may be controlled by a computer program, and a means for sensing a food portions core temperatures, then holding the food portion until the core temperature of the food portion has reached the requisite level.

In preferred embodiments the method for removing individual food portions from a mould uses apparatus including a spatula and a mould holder,

characterised in that the operation of the spatula and mould retention means are configured so that:

(a) the spatula can slide under the mould; and

(b) the mould holder lifts the mould causing the food to separate from the mould and be supported on the spatula

The spatula may come in any suitable form. For example, the spatula may be an elongated flat surface, or of a more rounded shape. An important requirement for the spatula is that it is of sufficient dimension to support the food portion removed from the mould.

In one embodiment of the present invention there is provided an automated mould extraction means for use in the production of meals including at least one mould retaining means; a spatula; and a mould evacuation means.

The mould evacuation means may come in any suitable form. In preferred embodiments it consists of a projection which exerts pressure on the food portion to assist in extracting adhesive food portions from the moulds.

In preferred embodiments the method of extracting food portions from moulds may include the steps of:

a) engaging the mould with the mould holder;

b) substantially simultaneously positioning the spatula underneath the food portion;

c) lifting the mould; and

d) evacuating the portion from the mould.

In preferred embodiments a method of retaining the food portions in specific position in a packaged meal prior to heating for the purposes of consumption may involve placing the food portions within an edible sauce in the meal package wherein after positioning the food portions, the sauce is sufficiently solid and of a sufficient depth to retain the food portions as placed within the sauce, and wherein upon heating, the sauce liquefies for consumption.

The edible sauce will now be referred to as a cold set sauce and may come in any suitable form. In preferred embodiments this sauce will be a gelatinous gravy which is substantially solid when chilled or at room temperature.

In preferred embodiments this cold set sauce will be of a sufficient depth for example, 5 mm to ensure the food remains firmly retained.

The aspects of this invention disclosed above have several advantages over the prior art.

By making the process almost wholly automated by removing human contact with the food in every stage except for the preparatory process results in substantially aseptic conditions. These aseptic conditions when implemented in conjunction with other steps in the process, for example, the use of a preservative spray, and flushing the packages before sealing with nitrogen and carbon dioxide gas result in a substantially longer shelf life.

The shelf life is extended from the standard seven to ten days to approximately twenty-one days, at the end of this twenty one days the APC counts still reveal very low numbers of bacteria

The increase in shelf life has the added advantage of allowing retailers to not be as accurate when ordering stock quantities, saving them both time and money. It also allows the ultimate consumer to keep the ready-made meal in their fridge for a significantly longer period, resulting in a more convenient meal for them.

By retaining the food portions in a holding area to ensure they are cooled to the proper level also significantly reduces the chances of bacterial spoilage. This variable retention duration enables food with different cooking times to be batch processed while still being cooled to its appropriate temperature.

Batch processing has the advantage over prior art in that it allows for more comprehensive quality control. For example, manufacturers can utilise this information to review suppliers as each batch can be traced back to the orchard or farm that were the initial suppliers. This allows manufacturers to assess the quality of each supplier.

The ability to batch process also allows for an easier cost accounting process.

This ability for batch processing also has the additional advantage over the prior art of allowing for specific batches to be recalled if contamination is found. This advantage saves the manufacturer a great deal of expense over issuing a general recall.

The use of the spatula and mould lifters in combination with the method aforementioned enables the food to be easily removed from the moulds while still retaining its shape. The method also allows for precise placing of the food within the packaging.

Both these features have the advantage of the prior art in that the resulting meal's appearance is far superior to that of the prior art.

The meals take the appearance more of a restaurant meal than of the bland non-appetising appearance of the ready-made meals currently available on the market.

The use of the cold set sauce to retain the portions in the places that they have been precisely laid by the assembly method aforementioned allows the meal to retain the appearance of a restaurant quality meal during transit between the manufacturers, the retailer, and the consumer.

The use of this sauce allows for a surprisingly rough treatment of the meals while still retaining the portions in their places. The sauce being cold set sauce upon heating liquefies and acts as a tasty sauce accompaniment for the meal.

The method described above for processing these ready-made meals is void of human contact in every stage except the preparatory process.

This allows the food to be prepared and cooked in aseptic conditions and results in a significantly longer shelf life.

The method also allows for batch processing, which enables manufacturers to evaluate suppliers, and discretely recall products if necessary.

The use of the shape holders and edible sauce allows the food to take the appearance of restaurant quality meals, and retain that appearance while being transported.

Once packaged into a meal, then in preferred embodiments the meal is chilled/refrigerated for distribution to retail outlets. In some situations, the meals may be frozen instead.

According to a further aspect of the present invention there is provided a monitoring means for use in a multiple stage sequential automatic food processing system characterised in that the monitoring means includes:

a means for assigning a unique identification to each individual food portion; and

sensors for measuring the values of one or more predetermined parameters of at least one stage of the process for said identified portions.

The term monitoring means should be read as including any computerised monitoring and control system for use in conjunction with a multiple stage sequential automatic food processing system.

Reference throughout this specification should now be made to the multiple stage sequential automatic food processing system as the cooking process. It should be appreciated however, that this term is not intended to be limiting in any way. The process includes all other stages found in such a system. These include but are not limited to cooking, chilling, resting, packaging, sorting and the like.

The means of assigning the unique identification may come in any suitable form.

In one embodiment of the present invention there is provided a means for assigning a unique identification to each food portion whereby each food portion individually enters the process and is assigned a sequential identifying alphanumeric code. For example, the meat portions may be assigned a letter ‘M’ followed by the order by which they enter into the process, i.e. M1, M2, M3 and so forth. The same could apply to vegetables, being assigned an alphanumeric code V1, V2, V3 and so forth.

In one embodiment of the present invention there is provided a means for assigning a unique identification to each food portion. The food portions enter the cooking process on trays. Each tray may be identified by a radio frequency tag.

In preferred embodiments each individual food portion on the tray will then be assigned a further alphanumeric code. This allows each individual food portion to be identified both by the tray it is on and its position on that tray.

In preferred embodiments each tray will be identified by a barcode incorporated onto the tray. Each food portion on the tray will then be assigned a further alphanumeric code. This allows each individual food portion to be identified both by the tray it is on and its position on that tray.

For example, a portion might reside on tray “0023”, and be in position “A4”. Thus the individual portion is assigned the identification code “0023A4”.

The parameter sensors may come in any suitable form, capable of monitoring the status of the food portions, and their surrounding environment.

In preferred embodiments, the sensors will record but not be limited to the following predetermined parameters:

the core temperature of the food portions;

the time taken to reach a certain points during the process;

environmental conditions,

filter effectiveness;

packaging integrity;

proximity of foreign objects; and

type of food portion.

In preferred embodiments the method of monitoring parameters in the multiple stage sequential food processing system is characterised by the steps of:

a) assigning individual food portions a unique identification code;

b) measuring parameter values with sensors;

c) recording the parameter values against each identified food portion creating a history for each; and

d) initiating an action against a food portion when parameter values in said history fall outside a specified parameter range.

The recordal method should be read as including and process, which allows for storage and retrieval of the recorded parameter values.

In preferred embodiments the parameters recorded will be recorded against each food portion by way of recordal in a spreadsheet, or database program.

The specified parameter ranges may come in any suitable form. For example, they might record a temperature range, or duration of one stage of the process, environmental contaminants and the like.

In some embodiments a parameter falling outside a specified range may take the form of a meat portion's core not attaining the temperature of 72° C. for a three minute period.

The specified parameter ranges may also incorporate binary output. For example, has the packaging process resulted in complete integrity? The parameter range will take the form of a yes or no answer.

The term history should read as being capable of including any information pertaining to an individual food portion or meal, which may be relevant to the process or in quality control management.

The action initiated against the food portion may come in any suitable form. In one embodiment the action may be that the food portion is extracted from a particular stage of the cooking process, and reintroduced into another. For example, if a portion of meat has not been sufficiently cooked then it can be returned and reintroduced into the actual cooking process.

In preferred embodiments if an individual food portion's history contains parameters which fall outside the specified parameter range then that food portion will be ejected from the process.

In preferred embodiments there is a method of analysis of the recorded parameters which includes the steps of:

a) recording an individual food portion's parameters creating an individual history; and

b) collating each individual history to form a complete meal history able to be analysed.

The term complete meal history should be read as being the sum of the individual food portion histories that are the components of a particular meal.

In preferred embodiments the information is collated and stored, for further analysis if required. Each complete meal is marked with an EAN barcode allowing an individual meal to be identified if any problems occur after the meal has left the cooking process.

The ability to record and analyse the exact conditions and properties of an individual food portion has two major advantages over previous batch quality control.

The first major advantage is that it allows individual portions to be preemptively removed from the process before any spoilage can occur. Thereby dramatically reducing the chance that a meal could spoil and cause any health problems for a consumer. It also allows entire meals to be removed from the process if it is likely that those meals will also cause quality issues.

The second major advantage is that it allows for complete auditability of the process, and raw materials. This ability to pinpoint the exact location of the problem ensures that it will not happen again. It also allows the processor to analyse the quality of each individual supplier, as it is envisaged that this information will also be contained as part of a portion or meals history. This provides clear evidence of whether a supplier is providing inferior goods.

### BRIEF DESCRIPTION OF DRAWINGS

Further aspects of the present invention will become apparent from the following description which is given by way of example only and with reference to the accompanying drawings in which:

FIG. 1 is a plan layout of the manufacturing floor or one embodiment for the production of the ready-made meals;

FIGS. 2A-D show side elevations of one embodiment of the shape holder, lifting apparatus and spatula arrangement in various stages of operation;

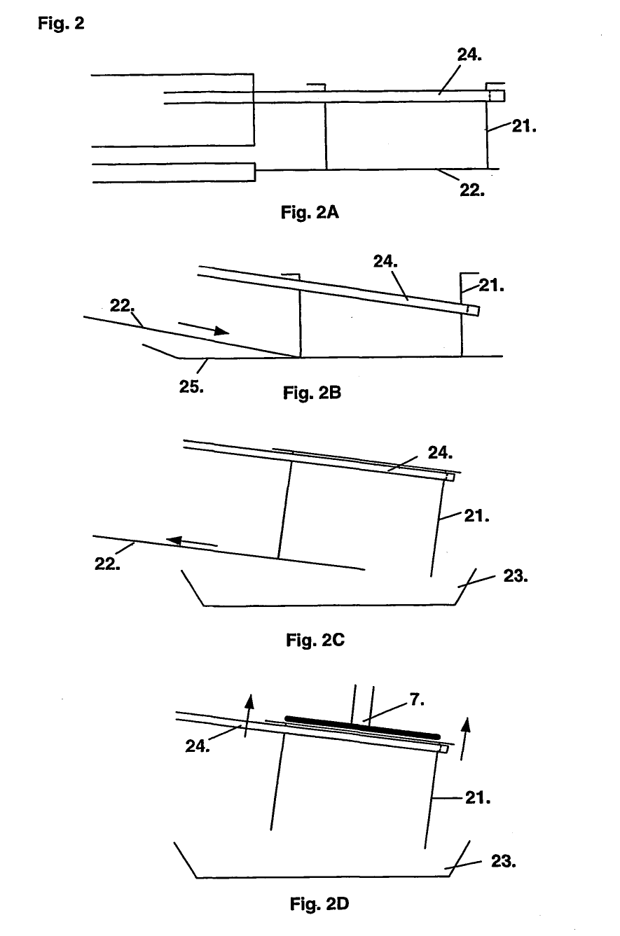

FIG. 3 shows a plan view of one embodiment of the shape holder, lifting apparatus arrangement;

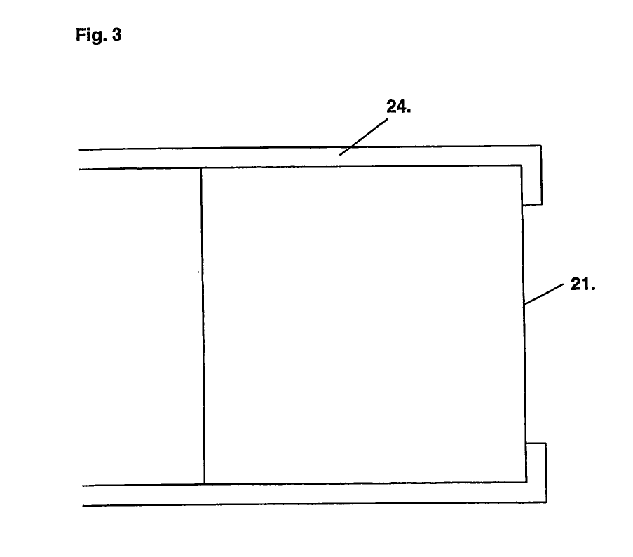

FIG. 4 a plan layout of one embodiment of the tray arrangement; and

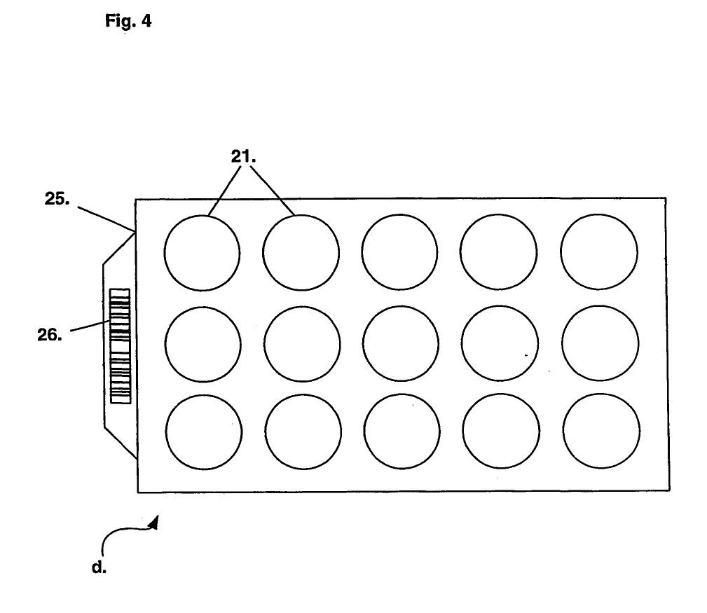

FIG. 5 a spreadsheet representation of the history for each meal.

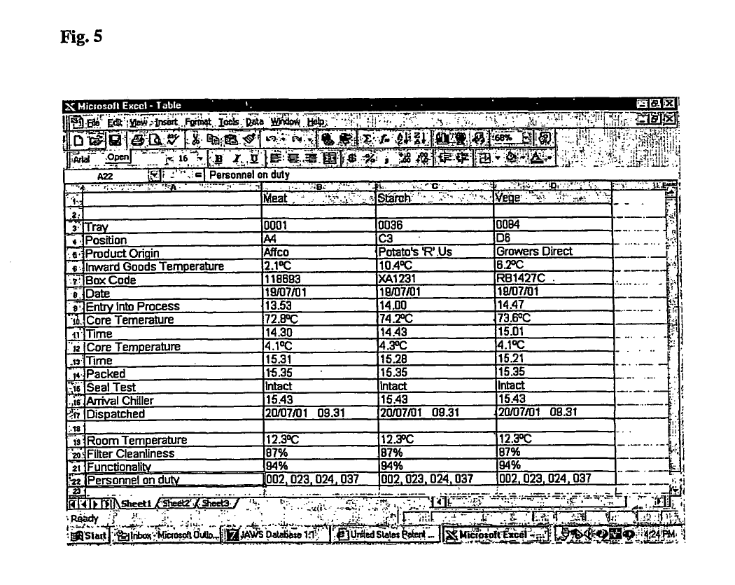

### BEST MODES FOR CARRYING OUT THE INVENTION

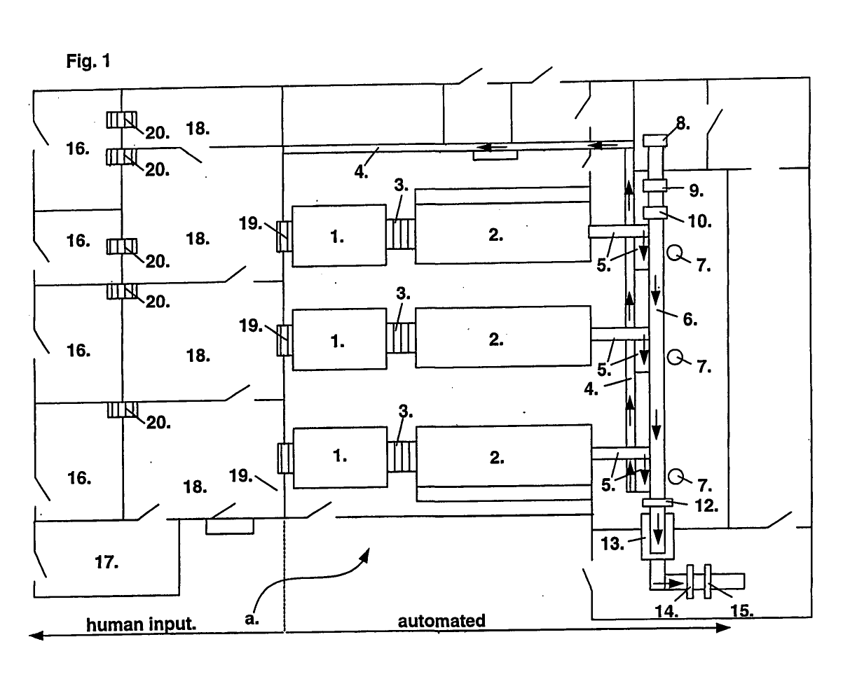

With respect to FIG. 1 there is illustrated a plan layout of the manufacturing floor of one in preferred embodiment of the method for producing ready-made meals generally indicated by arrow (a).

The method of producing these ready-made meals consists of two distinct phases. One phase involves human input, while the other phase is completely automated.

Human input is utilised during the preparatory phase. Whereby the ingredients for the ready-made meal are stored according to food types in chillers (16). The dry ingredients involved in the process are stored in a dry store (17).

The suppliers and initial food details are entered into a spreadsheet program. The data entered includes the supplier, the box code, the date of arrival, and the inward goods temperature.

The ingredients for the ready-made meals are transported to the prep rooms (18) via conveyors (20). In the prep rooms (18) workers make the necessary preparations for the cooking and packing process.

Some pre-cooking can occur in the prep room (18) before the food portions enter into the cooking process. This pre-cooking results in the food portions requiring less time in the process, thus enabling larger or slower cooking food portions to not delay the automated process. For example larger meat portions or portions of potato or pumpkin may be pre-cooked before entering the process in the prep room.

The last direct human contact with the food is when the prepared food portions are placed onto conveyors (19) to enter the cooking process.

After the necessary food preparation and arranging has occurred the food portions are placed into the appropriate shaped mould, for example rectangular, rounded or circular.

The food portions are automatically identified by tray number and the portion's position entered into the spreadsheet as well as the time that they enter the cooking process.

The conveyors (19) convey the food through inline ovens (1) whereby the food is cooked or steamed. The food portions then exit the inline ovens or steamers via conveyors (3).

After the cooking process the individual food portions have their core temperature recorded and the time the temperature was recorded.

The food portions are taken via the conveyors (3) into chillers (2).

The chillers (2) retain the food portions for varying times. This varying retention allows for the food to be properly cooled.

The temperature is recorded and checked, the time at which the temperature was taken is also recorded.

The food exits the chillers according to its core temperature via further conveying means (5).

The food portions and shape holders (21) are then lifted off the cooking trays (25) by the lifting apparatus (24). The food portions after removal from the shape holders (21) rest on the spatulas (22). The food portions which do not easily disengage from the shape holders (21) are then removed from the shape holders (21) by a robotic mechanism (7) used to apply pressure on the food portions.

These spatulas then position the food portions in the packaging (23), on the packaging conveyor (6).

The trays which the food portions were cooked on, and the shape holders (21) are then transferred to the tray return conveyor (4).

The packaging which retains the food during transportation are loaded onto the conveyor (6) by a tray loader means (8).

The trays are then sterilised by a package steriliser (9). The trays are then filled with the cold set sauce to a level between 3-10 mm by the sauce dispenser (10).

After all the food portions have been positioned in the packaging they are then sprayed with a flavour enhancer, and preservative by a spraying means (12). The trays are then sealed by the tray sealer (13).

The time at which the tray was sealed is recorded. The seal is then tested by checking for nitrogen or carbon dioxide gas in a pure oxygen gas cupboard. The results of this test are also recorded.

The sealed trays are then scanned for foreign material by under going x-ray bombardment while travelling through a x-ray machine (14).

The sterilised trays are then labeled with an EAN barcode by a labeler (15).

The sealed and sterilised trays are then stored for shipment. The time the meals arrive in the chiller is recorded, as is the date and time of their dispatch.

It addition to these specific time recordal there are also other general parameters recorded these include the room temperature, air filtered cleanliness, and functionality, and the personal on duty at the time of production.

All the information recorded is then collated and stored for further analysis.

Some examples of meals prepared using the present invention are given below.

### EXAMPLE 1

### Lamb Shanks

### Preparation of Meat

The shanks are cut to fit moulds. Rectangular moulds are greased, then the shanks are placed in the rectangular moulds. The shanks are lightly sprayed with oil, then sprinkled with salt and pepper. The shanks contained in the mould are placed into the oven on setting ‘LAMB SHANK’.

### Preparation of Starch Portion

Three kilos of potato are diced onto a large tray. Fifteen grams salt, five grams pepper, 100 mls of olive oil are added and mixed thoroughly. The potatoes are placed in the precook oven on setting ‘CRUSHED POTATO 1’. The precooked potatoes are placed into mixers and 100 mls of olive oil and 5 grams of Tuscan seasoning are added. 185 gram portions of seasoned potatoes are placed into greased double round moulds. Place in oven on setting ‘CRUSHED POTATO 2’.

### Vegetable Portion

Green beans are washed and bound with raffia in 100 gram bundles. The beans are then placed into greased rectangular moulds and then placed into the oven on setting ‘BEANS’.

### Cooking

The lamb shank is cooked for 25 minutes at 165° C., with a dew point of 90%. The potato is pre-cooked for 24 minutes at 180° C. with a dew point of 80%. The potato is then cooked for 8 minutes at 180° C. with a dew point of 70%. The green beans are cooked for 6 minutes at a temperature of 100° C. with a dew point of 100%.

### EXAMPLE 2

### Chicken Breasts

### Preparation of Meat

The chicken breasts are trimmed to size, then wrapped with streaky bacon. Rectangular moulds are greased and then filled with chicken. The breast is lightly sprayed with oil, then sprinkled with salt and pepper. A small amount of sage is sprinkled onto chicken breast, then it is placed into the oven on setting ‘CHICKEN BREAST’.

### Preparation of Starch Portion

Three kilos of potato are sliced into a large bowl. Seventy grams garlic, 30 grams salt, 10 gm pepper, 500 mls of cream are added and mixed thoroughly. The potato is then placed on a greased oven tray and precooked in an oven on setting ‘GRATIN POTATO 1’.

After pre-cooking the potatoes are pressed until they are flat, the potatoes are then cut into squares and placed into greased rectangular moulds, and placed into the oven on setting ‘GRATIN POTATO 2’.

### Vegetable Component

Eighty grams of broccoli into placed into rectangular moulds, and placed into the oven on setting ‘STEAMED BROCCOLI’.

### Cooking

The chicken breast is cooked for 20 minutes at 180° C., with a dew point of 90%. The potato is pre-cooked for 30 minutes at 180° C. with a dew point of 80%. The potato is then cooked for 6 minutes at 180° C. with a dew point of 40%. The broccoli is cooked for 7 minutes at a temperature of 100° C. with a dew point of 100%.

### EXAMPLE 3

### Lamb Rump

### Preparation of Meat

The lamb rump is trimmed to size and place in greased rectangular moulds, then lightly sprayed with oil. The lamb rump is then sprinkled with salt and pepper, and a small amount of sage. The lamb rump is then placed into the oven on setting ‘LAMB RUMP’.

### Preparation of Starch Portion

Three kilos of pumpkin are diced and mixed with 15 grams salt, 5 grams pepper and 100 mls of olive oil. The pumpkin is then placed in an oven dish and precooked on setting ‘PUMPKIN GALLETTE 1’.

The precooked pumpkin is then placed into a mixer and 100 mls of egg yolk and half a cup of chives are added and mixed. The mixture is then spooned into oval moulds and placed into the oven on setting ‘PUMPKIN GALLETTE 2’.

### Vegetable Component

250 mls of cream, 160 grams egg yolk, 5 grams pepper, and 16 grams salt are blended in a food processor. 450 grams spinach are washed and drained and blended for 30 seconds. The spinach and liquid components are mixed together until well combined. the spinach mousse is then spooned into double round moulds and place into oven on setting ‘SPINACH’.

### Cooking

The lamb rump is cooked for 12 minutes at 180° C., with a dew point of 80%. The pumpkin is precooked for 12.5 minutes at 180° C. with a dew point of 80%. The pumpkin is then cooked for 12 minutes at 180° C. with a dew point of 80%. The. spinach mousse is cooked for 19 minutes at 160° C. with a dew point of 70%.

It should be appreciated that in some embodiments of the present invention, some individual portions (such as the pumpkin, potato, and larger meat portions mentioned above) may be precooked before being subjected to the method of the present invention.

Aspects of the present invention have been described by way of example only and it should be appreciated that modifications and additions may be made thereto without departing-from the scope of the appended claims.

What we claim is:

1. A method of preparing meals characterised by the steps of:
a) using automated means to place food portions of different types into at least one oven wherein each food portion is contained within a mould; and
b) cooking the food portions in an oven; and
c) using automated means to remove the food from the oven; and
d) assembling the individual food portions into a meal within a package using automated means.

2. A method as claimed in claim 1 wherein the oven is an in-line oven.

3. A method according to claims 1 and 2, wherein the oven is capable of being programmed to operate to cook the food according to its type.

4. A method according to any one of claims 1 to 3 wherein the mould is baseless and contains at least one lip.

5. A method according to any one of claims 1 to 4 characterised by the further steps of:
a) retaining the food portions after they are cooked in a holding area; and
b) identifying when different types of food portions are to be retained in the holding area and retaining the food portions for a sufficient period so as to coordinate the assembly of a complete meal.

6. A method according to claim 5, wherein the holding area is a blast chiller.

7. A method according to either one of claims 5 or 6 wherein the period that the food portion is retained is determined by the core temperature of the individual food portion.

8. A method as claimed in any one of claims 1 to 7 wherein the apparatus used for removing individual food portions from a mould includes:
a spatula; and
a mould holder,
the method characterised in that the operation of the spatula and the mould holder are configured so that:
a) the spatula can slide under the mould; and
b) the mould holder lifts the mould to separate the food from the mould where it is held upon the spatula.

9. The method claimed in claim 8 further characterised by the step of:
c) exerting pressure on the food portion to remove it from the mould.

10. A method according to any one of claims 1 to 9 whereby food portions are retained in position in a packaged meal prior to heating characterised by the further steps of:
a) placing the food portions within an edible sauce within the meal package;
b) chilling the edible sauce thereby increasing its viscosity sufficiently to retain the food portions as positioned within the package; and
c) liquefying the sauce for consumption by heating.

11. A monitoring means when used with the method claimed in claim 1 characterised in that the monitoring means includes:
a) a means for assigning a unique identification to each individual food portion; and
b) sensors for measuring values of one or more predetermined parameters of the process for said identified portions.

12. The monitoring means as claimed in claim 11 wherein the unique identification is determined by the order the portions entered the process.

13. The monitoring means as claimed in either one of claims 11 or 12 wherein the food portions are placed on trays and the trays are provided with individual codes.

14. A monitoring means as claimed in any one of claims 11 to 13 wherein each individual food portion will be assigned a further alphanumeric code.

15. A monitoring means according to either claim 13 and 14 wherein the tray code and the individual portion code are linked to form a complete portion identification code.

16. A monitoring means as claimed in any one of claims 11 to 15 wherein one parameter measured is the core temperature of the food portions.

17. A monitoring means as claimed in any one of claims 11 to 16 wherein one of the parameters measured is duration of the process at specific points during the process.

18. A method of using the monitoring means claimed in any one of claims 11 to 17 characterised by the steps of:
a) assigning individual food portions a unique identification code;
b) measuring parameters with sensors; and
c) recording the measured parameter values against each individual food portion creating a history for each.

19. A method of claim 18 characterised by the further step of initiating an action against a food portion when parameter values in said history fall outside a specified parameter range.

20. The method of either claim 18 or 19 characterised by the further step of:
d) collating each individual history to form a complete meal history capable of being analysed.

21. An automated mould holder when used with the method as claimed in claim 1 including:
at least one mould holder capable of engaging with the mould and subsequently lifting the mould;
a mould evacuation means; and
a spatula to retain a food portion evacuated from the mould.

22. A method of preparing meals substantially as herein described with reference to and as illustrated by the accompanying drawings and description.

23. A method of removing a food portion from a mould substantially as herein described with reference to and as illustrated by the accompanying drawings and description.

24. A monitoring means substantially as herein described with reference to and as illustrated by the accompanying drawings and description.

25. An automated mould holder substantially as herein described with reference to and as illustrated by the accompanying drawings and description.
